(19) United States
(12) Patent Application Publication
(10) Pub. No.: US 2022/0387156 A1
(43) Pub. Date: Dec. 8, 2022

(54) Oral Therapy Apparatus

(71) Applicant: Cheri Rae Harris Rubottom, Seal Beach, CA (US)

(72) Inventor: Cheri Rae Harris Rubottom, Seal Beach, CA (US)

(21) Appl. No.: 17/339,127

(22) Filed: Jun. 4, 2021

(51) Int. Cl. A61C 19/06; A61C 7/36

(52) U.S. Cl. CPC A61C 19/063; A61C 7/36; A61C 2201/00

(57) ABSTRACT

An oral therapy apparatus is disclosed and configured for being positionable within a mouth of a user having orthodontic braces. In at least one embodiment, the apparatus provides a flexible, substantially cylindrical, elongated body sized and configured for being positioned within the user's mouth, substantially between gums of the user and an inner surface of the user's mouth. The body has a diameter sized for creating a space between the inner surface of the user's mouth and the braces, thereby preventing the inner surface of the user's mouth from coming into contact with the braces.

### RELATED APPLICATIONS

Not applicable.

### BACKGROUND

The subject of this patent application relates generally to dental devices, and more particularly to an oral therapy apparatus configured for providing relief to patients recovering form oral surgery, as well as patients who are wearing orthodontic devices such as braces.

Applicant(s) hereby incorporate herein by reference any and all patents and published patent applications cited or referred to in this application.

By way of background, patients who undergo oral surgery—such as gum surgery, for example—often deal with a period of discomfort and/or soreness (hereinafter generally referred to as “pain” for simplicity purposes) while they recover from the procedure, which could potentially last for days. Pain is also typically experienced by patients with orthodontic braces—particularly when the braces are first put on, as well as each time the braces are subsequently tightened. Traditionally, such pain is managed with an oral anesthetic, or the application of cold (such as an ice cube, ice pack or popsicle) or heat (such as a heating pad) against the affected area. However, given the relatively tight dimensions of a typical mouth, such cold and heat sources tend to be difficult to maintain in position against the affected area. One other solution that has been developed in an attempt to administer pain relief to a patient's mouth is a product marketed under the name ORACHILL. In a bit more detail, the ORACHILL device is a mouthpiece having an upper portion sized and configured for being positioned between the upper gums and the inside surface of the patient's mouth, and an opposing lower portion sized and configured for being positioned between the lower gums and the inside surface of the patient's mouth, with the upper and lower portions joined by a pair of hinges. Each of the upper and lower portions is tubular in cross-section and is filled with a freezable non-toxic saline solution, thereby enabling the device to be frozen and subsequently inserted into the patient's mouth in order to provide only two minutes of pain relief (given the relatively small diameter of each of the upper and lower portions and, thus, the relatively small amount of freezable solution positioned therewithin). Given the short effective time of the ORACHILL product, it is packaged with three mouthpieces in order to give the patient up to six minutes of pain relief (assuming all three of the mouthpieces are concurrently frozen). But even six minutes of pain relief could prove insufficient for a patient experiencing pain for hours or even days.

Another source of oral pain, patients with braces may experience scrapes or sores on the inner surfaces of their mouth due to the metal brackets or wires of the braces (hereinafter generally referred to as “braces” for simplicity purposes) rubbing against them. Traditionally, orthodontic wax is placed on the braces in order to provide a barrier between the braces and the inner surfaces of the patient's mouth. However, such wax can become tedious to apply and re-apply, while also being messy; sometimes even becoming stuck to the braces and requiring extra time and care to fully remove. One other solution that has been developed in an attempt to protect the inner surfaces of a patient's mouth is described in U.S. Pat. No. 4,609,348 to Rowland. In a bit more detail, the Rowland device consists of a thin strip of sponge-like cellular material formed to fit into the patient's mouth and lie between the braces and the line of joinder between the gum and inner cheek. The major portion of each strip is approximately 0.125 inches thick with its opposite ends tapered to a thickness of 0.0625 inches. Additionally, as illustrated in FIGS. 1 and 2 of Rowland, the curved edge of each strip actually lies overtop the braces, thus covering them similar to traditional orthodontic wax (though presumably not as messy). As such, given that braces are typically visible when a patient smiles, the Rowland device would be visible as well, which is less than ideal from an aesthetic perspective—even if the strips are flesh colored, as described in Rowland.

Thus, there remains a need for a solution capable of more effectively providing relief to patients recovering form oral surgery, as well as patients who are wearing orthodontic devices such as braces. Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing an oral therapy apparatus configured for being positionable within a mouth of a user having orthodontic braces. In at least one embodiment, the apparatus provides a flexible, substantially cylindrical, elongated body sized and configured for being positioned within the user's mouth, substantially between gums of the user and an inner surface of the user's mouth. The body has a diameter sized for creating a space between the inner surface of the user's mouth and the braces, thereby preventing the inner surface of the user's mouth from coming into contact with the braces.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIGS. 1 and 2 are top plan views of an exemplary oral therapy apparatus, in accordance with at least one embodiment;

FIG. 3 is a perspective view of a pair of the exemplary oral therapy apparatus positioned within a mouth of a user, in accordance with at least one embodiment;

FIG. 4 is a further perspective view of a pair of the exemplary oral therapy apparatus positioned within a mouth of a user with braces, in accordance with at least one embodiment; and

FIG. 5 is a diagrammatic side view of a pair of the exemplary oral therapy apparatus positioned within a mouth of a user with braces, in accordance with at least one embodiment, with a portion of the user's mouth cut away for illustrative purposes.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

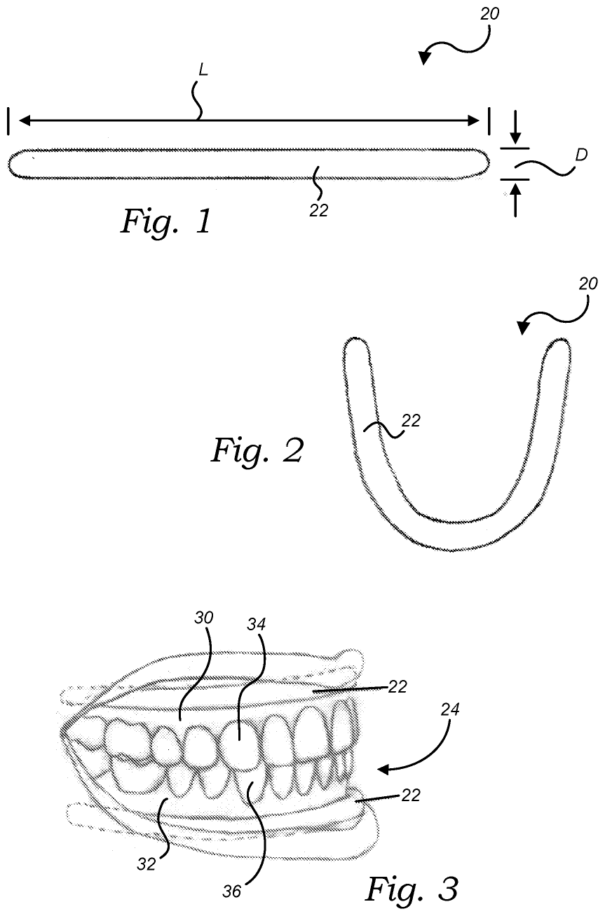

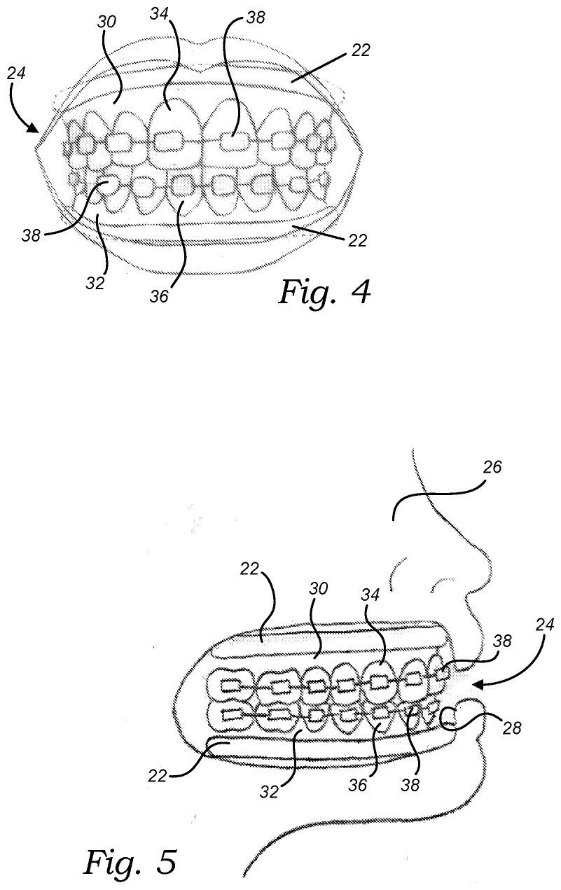

Turning now to FIGS. 1 and 2, there are shown top plan views of an exemplary oral therapy apparatus 20, in accordance with at least one embodiment. In at least one embodiment, the apparatus 20 provides a flexible, substantially cylindrical, elongated body 22 sized and configured for being positioned inside of a mouth 24 of a user 26 (FIGS. 3 and 4), substantially between an inner surface 28 of the user's mouth 24 and either the upper gums 30 or lower gums 32, depending on the desired placement of the apparatus 20 (i.e., depending on whether the user 26 desires to provide relief proximal their upper gums 30 or lower gums 32), so as to space the inner surface 28 of the user's mouth 24 a distance apart from the corresponding upper teeth 34 or lower teeth 36 within the user's mouth 28. In at least one embodiment, the body 22 is positionable within the user's mouth 24 so as to lie proximal to and parallel with the line of joinder between the inner surface 28 of the user's mouth 24 and the gums 30 or 32. Accordingly, in at least one embodiment, the body 22 is capable of conforming to the shape and curvature of either the upper gums 30 or lower gums 32.

In at least one embodiment, the body 22 is further configured for extending along the entire row of corresponding teeth 34 or 36 (i.e., either the upper teeth 34 or lower teeth 36). In at least one alternate embodiment, the body 22 is configured for extending along at least a portion of the entire row of corresponding teeth 34 or 36. Thus, in at least one embodiment, the body 22 has a length L that is dependent at least in part on the location of pain (or potential pain) within the user's mouth 24. Additionally, in at least one embodiment, where the user's teeth 34 or 36 include braces 38, the body 22 has a diameter D that is sized for creating a space between the inner surface 28 of the user's mouth 28 and the braces 38 (as best illustrated in FIG. 5), thus preventing the inner surface 28 of the user's mouth 28 from coming into contact with the braces 38 which, in turn, protects the inner surface 28 of the user's mouth 28 from irritation and subsequent pain. Furthermore, in at least one embodiment, the length L and diameter D of the body 22 are such that the body 22 is capable of being frictionally positioned between the inner surface 28 of the user's mouth 28 and the corresponding gums 30 or 32, thereby preventing the body 22 from unintentionally moving out of position during use of the apparatus 20 without any need for adhesives or any other engagement mechanisms or materials. In at least one embodiment, the body 22 has a length L of between approximately 1 inch and approximately 6 inches, and a substantially uniform diameter D of between approximately 0.25 inches and approximately 0.75 inches. However, in that regard, it should be noted that the specific size, shape and dimensions of the body 22 as depicted in the drawings (and as described herein) is merely exemplary; thus, in further embodiments, the body 22 may take on any other sizes, shapes and/or dimensions now known or later developed—dependent at least in part on the dimensions of the user's mouth 24, the location of pain (or potential pain) within the user's mouth 24, and the presence or absence of braces 38—so long as the apparatus 20 is capable of substantially carrying out the functionality described herein. Additionally, in at least one embodiment, the user 26 may utilize one body 22 for the upper gums 30, and another body 22 for the lower gums 32. In such embodiments, it should be noted that the respective sizes, shapes and dimensions of each body 22 may be the same, or may be different—again, dependent at least in part on the dimensions of the user's mouth 24, the location of pain (or potential pain) within the user's mouth 24, and the presence or absence of braces 38.

In at least one embodiment, the body 22 is constructed out of a relatively soft, resilient material that is capable of temporarily conforming to the user's gums 30 or 32, such as fabric, mesh, plastic, vinyl, leather or rubber (such as nitrile) for example. In at least one such embodiment, the body 22 is constructed out of a material that is also non-allergenic. In at least one further embodiment, the body 22 is constructed out of a material that is also capable of withstanding extreme hot and/or extreme cold temperatures, as discussed further below. In at least one still further embodiment, the body 22 is constructed out of a thermoformable material that is capable of being molded to fit the user's gums 30 or 32. In still further embodiments, the body 22 may be constructed out of any other material (or combination of materials)—now known or later developed—capable of allowing the body 22 to substantially carry out the functionality described herein. In at least one embodiment, the body 22 is disposable; while in at least one alternate embodiment, the body 22 is reusable.

In at least one embodiment, the body 22 is filled with a non-toxic, non-allergenic, food grade material (such as a gel or a liquid, for example) capable of being chilled (by placing the apparatus 20 in a freezer or refrigerator, for example) so as to provide cold therapy to the user's gums 30 or 32 when the body 22 is subsequently positioned within the user's mouth 24. In at least one such embodiment, the material has a high specific heat capacity so as to chill without fully freezing, and to maximize cold retention. Examples of such materials include, but are in no way limited to, glucose syrup and corn syrup. Accordingly, in at least one embodiment, where the body 22 has a length of approximately 4.5 inches and a substantially uniform diameter of approximately 0.25 inches, the apparatus 20 may be worn for approximately five minutes or longer while retaining a sufficient temperature; and even after the apparatus 20 returns to room temperature, it can continue to be worn comfortably so as to maintain a space between the inner surface 28 of the user's mouth 28 and the braces 38, thus preventing the inner surface 28 of the user's mouth 28 from coming into contact with the braces 38. In at least one alternate embodiment, the body 22 is filled with a non-toxic, non-allergenic, food grade material (such as a gel or a liquid, for example) capable of being heated (by placing the apparatus 20 in a microwave or hot water, for example) so as to provide heat therapy to the user's gums 30 or 32 when the body 22 is subsequently positioned within the user's mouth 24. In at least one such embodiment, the material has a high specific heat capacity so as to heat without hardening, and to maximize heat retention. Examples of such materials include, but are in no way limited to, glucose syrup and corn syrup. In at least one still further embodiment, the body 22 is filled with a non-toxic, non-allergenic, food grade material (such as a gel or a liquid, for example) capable of being selectively chilled or heated so as to provide the desired type of temperature-based therapy to the user's gums 30 or 32 when the body 22 is subsequently positioned within the user's mouth 24. Examples of such materials include, but are in no way limited to, glucose syrup and corn syrup. In at least one still further embodiment, the material is an emulsion polymer, such as polyurethane foam, for example. In still further embodiments, the material may be any other material (or combination of materials)—now known or later developed—capable of allowing the body 22 to substantially carry out the functionality described herein.

In at least one embodiment, the body 22 is constructed out of, or otherwise impregnated, coated or filled with an at least one drug or drug releasing agent (hereinafter generally referred to as a “therapeutic” for simplicity purposes), such that the at least one therapeutic is capable of being automatically administered to the user 26 when the body 22 is positioned within the user's mouth 24. In at least one such embodiment, the at least one therapeutic is an oral anesthetic to help desensitize the user's mouth 24. In further embodiments, any other therapeutic (now known or later developed), capable of being administered to the user 26 via the user's mouth 24, may be incorporated.

Aspects of the present specification may also be described as the following embodiments:

1. An oral therapy apparatus positionable within a mouth of a user having orthodontic braces, the apparatus comprising: a flexible, substantially cylindrical, elongated body sized and configured for being positioned within the user's mouth, substantially between gums of the user and an inner surface of the user's mouth; and the body having a substantially uniform diameter sized for creating a space between the inner surface of the user's mouth and the braces, thereby preventing the inner surface of the user's mouth from coming into contact with the braces.

2. The oral therapy apparatus according to embodiment 1, wherein the body is positionable within the user's mouth so as to lie proximal to and parallel with a line of joinder between the inner surface of the user's mouth and the gums.

3. The oral therapy apparatus according to embodiments 1-2, wherein the body has a length sized for extending along at least a portion of an entire row of teeth of the user.

4. The oral therapy apparatus according to embodiments 1-3, wherein the length of the body is sized for extending along the entire row of teeth of the user.

5. The oral therapy apparatus according to embodiments 1-4, wherein the length and diameter of the body are sized for allowing the body to be frictionally positioned between the inner surface of the user's mouth and the gums.

6. The oral therapy apparatus according to embodiments 1-5, wherein: the body has a length of between approximately 1 inch and approximately 6 inches; and the body has a diameter of between approximately 0.25 inches and approximately 0.75 inches.

7. The oral therapy apparatus according to embodiments 1-6, wherein the body has a length of approximately 4.5 inches, and a diameter of approximately 0.25 inches.

8. The oral therapy apparatus according to embodiments 1-7, wherein the body is constructed out of a relatively soft, resilient material that is capable of temporarily conforming to the user's gums when the body is positioned within the user's mouth.

9. The oral therapy apparatus according to embodiments 1-8, wherein the body is constructed out of at least one of fabric, mesh, plastic, vinyl, leather and rubber.

10. The oral therapy apparatus according to embodiments 1-9, wherein the body is constructed out of a thermoformable material that is capable of being molded to fit the user's gums.

11. The oral therapy apparatus according to embodiments 1-10, wherein the body is filled with a non-toxic, non-allergenic, food grade material capable of being chilled so as to provide cold therapy to the user's gums when the body is subsequently positioned within the user's mouth.

12. The oral therapy apparatus according to embodiments 1-11, wherein the material has a high specific heat capacity so as to enable the body to be chilled without fully freezing, while also maximizing cold retention within the body.

13. The oral therapy apparatus according to embodiments 1-12, wherein the material is chosen from at least one of glucose syrup and corn syrup.

14. The oral therapy apparatus according to embodiments 1-13, wherein the body is filled with a non-toxic, non-allergenic, food grade material capable of being heated so as to provide heat therapy to the user's gums when the body is subsequently positioned within the user's mouth.

15. The oral therapy apparatus according to embodiments 1-14, wherein the material has a high specific heat capacity so as to enable the body to be heated without hardening, while also maximizing heat retention within the body.

16. The oral therapy apparatus according to embodiments 1-15, wherein the material is chosen from at least one of glucose syrup and corn syrup.

17. The oral therapy apparatus according to embodiments 1-16, wherein the body is filled with a non-toxic, non-allergenic, food grade material capable of being selectively chilled or heated so as to provide a desired type of temperature-based therapy to the user's gums when the body is subsequently positioned within the user's mouth.

18. The oral therapy apparatus according to embodiments 1-17, wherein the material is chosen from at least one of glucose syrup and corn syrup.

19. The oral therapy apparatus according to embodiments 1-18, wherein the body provides an at least one therapeutic capable of being automatically administered to the user when the body is positioned within the user's mouth.

20. The oral therapy apparatus according to embodiments 1-19, wherein the body is constructed out of, or otherwise impregnated, coated or filled with the at least one therapeutic.

21. The oral therapy apparatus according to embodiments 1-20, wherein the at least one therapeutic is an oral anesthetic to help desensitize the user's mouth.

22. An oral therapy apparatus positionable within a mouth of a user having orthodontic braces, the apparatus comprising: a flexible, substantially cylindrical, elongated body sized and configured for being positioned within the user's mouth, substantially between gums of the user and an inner surface of the user's mouth; and the body having a substantially uniform diameter of between approximately 0.25 inches and approximately 0.75 inches for creating a space between the inner surface of the user's mouth and the braces, thereby preventing the inner surface of the user's mouth from coming into contact with the braces.

23. An oral therapy apparatus positionable within a mouth of a user having orthodontic braces affixed to each of a plurality of upper teeth and a plurality of lower teeth, the apparatus comprising: a flexible, substantially cylindrical, elongated first body sized and configured for being positioned within the user's mouth, substantially between upper gums of the user and an inner surface of the user's mouth, the first body having a substantially uniform diameter sized for creating a space between the inner surface of the user's mouth and the braces of the upper teeth, thereby preventing the inner surface of the user's mouth from coming into contact with said braces; and a flexible, substantially cylindrical, elongated second body sized and configured for being positioned within the user's mouth, substantially between lower gums of the user and an inner surface of the user's mouth, the second body having a substantially uniform diameter sized for creating a space between the inner surface of the user's mouth and the braces of the lower teeth, thereby preventing the inner surface of the user's mouth from coming into contact with said braces.

In closing, regarding the exemplary embodiments of the present invention as shown and described herein, it will be appreciated that an oral therapy apparatus is disclosed and configured for providing relief to patients recovering form oral surgery, as well as patients who are wearing orthodontic devices such as braces. Because the principles of the invention may be practiced in a number of configurations beyond those shown and described, it is to be understood that the invention is not in any way limited by the exemplary embodiments, but is generally directed to an oral therapy apparatus and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An oral therapy apparatus positionable within a mouth of a user having orthodontic braces, the apparatus comprising:
a flexible, substantially cylindrical, elongated body sized and configured for being positioned within the user's mouth, substantially between gums of the user and an inner surface of the user's mouth; and
the body having a substantially uniform diameter sized for creating a space between the inner surface of the user's mouth and the braces, thereby preventing the inner surface of the user's mouth from coming into contact with the braces.

2. The oral therapy apparatus of claim 1, wherein the body is positionable within the user's mouth so as to lie proximal to and parallel with a line of joinder between the inner surface of the user's mouth and the gums.

3. The oral therapy apparatus of claim 1, wherein the body has a length sized for extending along at least a portion of an entire row of teeth of the user.

4. The oral therapy apparatus of claim 3, wherein the length of the body is sized for extending along the entire row of teeth of the user.

5. The oral therapy apparatus of claim 3, wherein the length and diameter of the body are sized for allowing the body to be frictionally positioned between the inner surface of the user's mouth and the gums.

6. The oral therapy apparatus of claim 5, wherein:
the body has a length of between approximately 1 inch and approximately 6 inches; and
the body has a diameter of between approximately 0.25 inches and approximately 0.75 inches.

7. The oral therapy apparatus of claim 6, wherein the body has a length of approximately 4.5 inches, and a diameter of approximately 0.25 inches.

8. The oral therapy apparatus of claim 1, wherein the body is constructed out of a relatively soft, resilient material that is capable of temporarily conforming to the user's gums when the body is positioned within the user's mouth.

9. The oral therapy apparatus of claim 8, wherein the body is constructed out of at least one of fabric, mesh, plastic, vinyl, leather and rubber.

10. The oral therapy apparatus of claim 1, wherein the body is constructed out of a thermoformable material that is capable of being molded to fit the user's gums.

11. The oral therapy apparatus of claim 1, wherein the body is filled with a non-toxic, non-allergenic, food grade material capable of being chilled so as to provide cold therapy to the user's gums when the body is subsequently positioned within the user's mouth.

12. The oral therapy apparatus of claim 11, wherein the material has a high specific heat capacity so as to enable the body to be chilled without fully freezing, while also maximizing cold retention within the body.

13. The oral therapy apparatus of claim 1, wherein the body is filled with a non-toxic, non-allergenic, food grade material capable of being heated so as to provide heat therapy to the user's gums when the body is subsequently positioned within the user's mouth.

14. The oral therapy apparatus of claim 13, wherein the material has a high specific heat capacity so as to enable the body to be heated without hardening, while also maximizing heat retention within the body.

15. The oral therapy apparatus of claim 1, wherein the body is filled with a non-toxic, non-allergenic, food grade material capable of being selectively chilled or heated so as to provide a desired type of temperature-based therapy to the user's gums when the body is subsequently positioned within the user's mouth.

16. The oral therapy apparatus of claim 1, wherein the body provides an at least one therapeutic capable of being automatically administered to the user when the body is positioned within the user's mouth.

17. The oral therapy apparatus of claim 16, wherein the body is constructed out of, or otherwise impregnated, coated or filled with the at least one therapeutic.

18. The oral therapy apparatus of claim 16, wherein the at least one therapeutic is an oral anesthetic to help desensitize the user's mouth.

19. An oral therapy apparatus positionable within a mouth of a user having orthodontic braces, the apparatus comprising:
a flexible, substantially cylindrical, elongated body sized and configured for being positioned within the user's mouth, substantially between gums of the user and an inner surface of the user's mouth; and
the body having a substantially uniform diameter of between approximately 0.25 inches and approximately 0.75 inches for creating a space between the inner surface of the user's mouth and the braces, thereby preventing the inner surface of the user's mouth from coming into contact with the braces.

20. An oral therapy apparatus positionable within a mouth of a user having orthodontic braces affixed to each of a plurality of upper teeth and a plurality of lower teeth, the apparatus comprising:
a flexible, substantially cylindrical, elongated first body sized and configured for being positioned within the user's mouth, substantially between upper gums of the user and an inner surface of the user's mouth, the first body having a substantially uniform diameter sized for creating a space between the inner surface of the user's mouth and the braces of the upper teeth, thereby preventing the inner surface of the user's mouth from coming into contact with said braces; and
a flexible, substantially cylindrical, elongated second body sized and configured for being positioned within the user's mouth, substantially between lower gums of the user and an inner surface of the user's mouth, the second body having a substantially uniform diameter sized for creating a space between the inner surface of the user's mouth and the braces of the lower teeth, thereby preventing the inner surface of the user's mouth from coming into contact with said braces.
